(19) United States
(12) Patent Application Publication
(10) Pub. No.: US 2015/0333340 A1
(43) Pub. Date: Nov. 19, 2015

(54) FLOW FIELDS FOR USE WITH AN ELECTROCHEMICAL CELL

(71) Applicant: Nuvera Fuel Cells, Inc., Billerica, MA (US)

(72) Inventors: Benjamin S. Lunt, Tewksbury, MA (US); Filippo Gambini, Boston, MA (US); Amedeo Conti, Somerville, MA (US)

(73) Assignee: Nuvera Fuel Cells, Inc., Billerica, MA (US)

(21) Appl. No.: 14/710,990

(22) Filed: May 13, 2015

Related U.S. Application Data
(60) Provisional application No. 61/993,911, filed on May 15, 2014.

(51) Int. Cl. H01M 8/02; C25B 11/02

(52) U.S. Cl. CPC H01M 8/0232; C25B 11/02; H01M 8/0258; H01M 2008/1095

(57) ABSTRACT

A flow field for use in an electrochemical cell is disclosed. The flow field includes a porous metallic structure including an inlet port and an outlet port. The flow field further includes a plurality of first channels formed in the structure. Each of the plurality of first channels extends from a first proximal end in fluid communication with the inlet port and terminates at a first distal end within the structure. The flow field also includes a plurality of second channels formed in the structure. Each of the plurality of second channels extends from a second distal end in fluid communication with an outlet port and terminates at a second proximal end within the structure.

This application claims the benefit of U.S. Provisional Application No. 61/993,911, filed May 15, 2014, which is incorporated by reference in its entirety.

The present disclosure is directed to electrochemical cells and, more specifically, to the design of flow fields for use in electrochemical cells.

Electrochemical cells, usually classified as fuel cells or electrolysis cells, are devices used for generating current from chemical reactions, or inducing a chemical reaction using a flow of current. A fuel cell converts the chemical energy of fuel (e.g., hydrogen, natural gas, methanol, gasoline, etc.) and an oxidant (air or oxygen) into electricity and waste products of heat and water. A basic fuel cell comprises a negatively charged anode, a positively charged cathode, and an ion-conducting material called an electrolyte.

Different fuel cell technologies utilize different electrolyte materials. A Proton Exchange Membrane (PEM) fuel cell, for example, utilizes a polymeric ion-conducting membrane as the electrolyte. In a hydrogen PEM fuel cell, hydrogen atoms are electrochemically split into electrons and protons (hydrogen ions) at the anode. The electrons then flow through the circuit to the cathode and generate electricity, while the protons diffuse through the electrolyte membrane to the cathode. At the cathode, hydrogen protons combine with electrons and oxygen (supplied to the cathode) to produce water and heat.

An electrolysis cell represents a fuel cell operated in reverse. A basic electrolysis cell functions as a hydrogen generator by decomposing water into hydrogen and oxygen gases when an external electric potential is applied. The basic technology of a hydrogen fuel cell or an electrolysis cell can be applied to electrochemical hydrogen manipulation, such as, electrochemical hydrogen compression, purification, or expansion. Electrochemical hydrogen manipulation has emerged as a viable alternative to the mechanical systems traditionally used for hydrogen management. Successful commercialization of hydrogen as an energy carrier and the long-term sustainability of a “hydrogen economy” depend largely on the efficiency and cost-effectiveness of fuel cells, electrolysis cells, and other hydrogen manipulation/management systems.

In operation, a single fuel cell can generally generate about 1 volt. To obtain the desired amount of electrical power, individual fuel cells are combined to form a fuel cell stack, wherein fuel cells are stacked together sequentially. Each fuel cell may include a cathode, an electrolyte membrane, and an anode. A cathode/membrane/anode assembly constitutes a “membrane electrode assembly,” or “MEA,” which is typically supported on both sides by bipolar plates. Reactant gases (hydrogen and air or oxygen) are supplied to the electrodes of the MEA through channels or grooves formed in the plates, which are known as flow fields. In addition to providing mechanical support, the biopolar plates (also known as flow field plates or separator plates) physically separate individual cells in a stack while electrically connecting them. A typical fuel cell stack includes manifolds and inlet ports for directing the fuel and oxidant to the anode and cathode flow fields, respectively. A fuel cell stack also includes exhaust manifolds and outlet ports for expelling the excess gases and the coolant water.

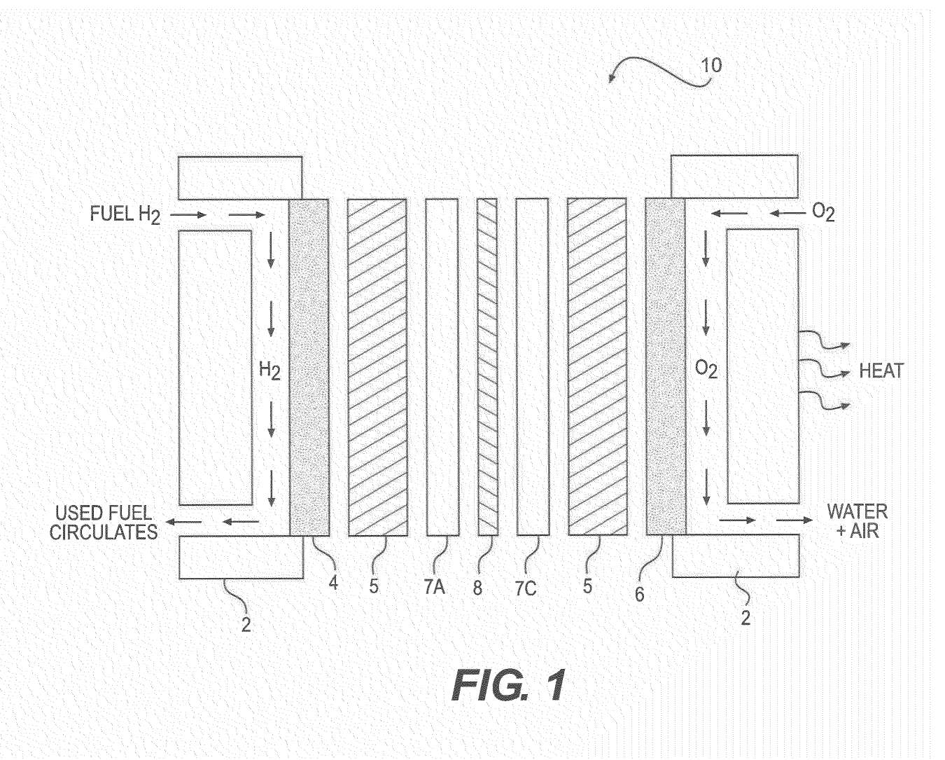

FIG. 1 is an exploded schematic view showing the various components of a prior art PEM fuel cell 10. As illustrated, bipolar plates 2 flank the “membrane electrode assembly” (MEA), which comprises an anode 7A, a cathode 7C, and an electrolyte membrane 8. Hydrogen atoms supplied to anode 7A are electrochemically split into electrons and protons (hydrogen ions). The electrons flow through an electric circuit to cathode 7C and generate electricity in the process, while the protons move through electrolyte membrane 8 to cathode 7C. At the cathode, protons combine with electrons and oxygen (supplied to the cathode) to produce water and heat.

Additionally, prior art PEM fuel cell 10 includes electrically-conductive gas diffusion layers (GDLs) 5 within the cell on each side of the MEA. Gas diffusion layers 5 serve as diffusion media enabling the transport of gases and liquids within the cell, provide electrically conduction between bipolar plates 2 and electrolyte membrane 8, aid in the removal of heat and process water from the cell, and in some cases, provide mechanical support to electrolyte membrane 8. Gas diffusion layers 5 can comprise a woven or non-woven carbon cloth with electrodes 7A and 7C coated on the sides facing the electrolyte membrane. In some cases the electrocatalyst material can be coated onto either the adjacent GDL 5 or the electrolyte membrane 8.

Generally, carbon-fiber based gas diffusion layers do not meet the performance requirements of a high-differential pressure cell, particularly because of limited structural properties of these materials. Therefore, some high-pressure electrochemical cells use “fit-type” densely sintered metals, screen packs, or expanded metals in combination with or as a replacement for traditional GDLs to provide structural support to the MEA in combination with traditional, land-channel flow fields 4 formed in the bipolar plates 2. Layered structures (i.e., screen packs and expanded metals) provide relatively thick structures suitable for high differential pressure operations. However, they introduce other performance penalties such as, for example, high contact resistance, high flow resistance, large cell pitch, etc. To overcome the physical limitations of these layered structures, three-dimensional porous metallic structures can be used as a replacement for traditional land-channel flow fields 4 and GDLs 5 in high differential pressure electrochemical cells.

In an electrochemical cell using porous metallic flow fields, reactant gases on each side of the electrolyte membrane flow through the porous metallic flow fields to reach the electrolyte membrane. A continuous flow through the porous metallic flow fields ensures that, while most the fuel or oxidant is consumed, the depleted oxidant is continually flushed from the fuel cell. Like traditional land-channel flow fields, it is desirable that these porous metallic structures facilitate the even distribution of the reactant gas to the electrode so as to achieve high performance of an individual fuel cell. Additionally, it is desirable not to create excessive pressure drop in the reactant gas flow, which can otherwise consume some of the electrical energy generated by the fuel cell stack and lower the overall efficiency of the fuel cell stack. As such, there is a continuing challenge to improve the design of the porous metallic flow fields to provide improved distribution of reactant gases, but without the addition of further components to the cell.

The present disclosure is directed towards the design of flow fields for use with electrochemical cells. In particular, the present disclosure is directed towards the design of porous metallic flow fields for use in electrochemical cells for improving the distribution of reactant gases. These devices can be used in electrochemical cells operating under high differential pressures including, but not limited to, fuel cells, electrolysis cells, and hydrogen compressors.

One aspect of the present disclosure is directed to a flow field for use in an electrochemical cell. The flow field can include a porous metallic structure including an inlet port and an outlet port. The flow field can further include a plurality of first channels formed in the structure. Each of the plurality of first channels extends from a first proximal end in fluid communication with the inlet port and terminates at a first distal end within the structure. The flow field can also include a plurality of second channels formed in the structure. Each of the plurality of second channels extends from a second distal end in fluid communication with an outlet port and terminates at a second proximal end within the structure.

Another aspect of the present disclosure is directed to an electrochemical cell. The electrochemical cell can include a first bipolar plate, a second bipolar plate, and a membrane electrode assembly comprising a cathode, an anode, and a polymer membrane disposed between the cathode and the anode. The electrochemical cell can also include at least one flow field disposed between one of the first bipolar plate and the second bipolar plate and the membrane electrode assembly. The at least one flow field can be formed of a porous metallic structure having an inlet port and an outlet port. The structure can further include a plurality of inlet channels in fluid communication with the inlet port, and a plurality of outlet channels interposed between each of the plurality of inlet channels and in fluid communication with the outlet port.

It is to be understood that both the foregoing general description and the following detailed description are exemplary and explanatory only and are not restrictive of the disclosure, as claimed.

The accompanying drawings, which are incorporated in and constitute a part of this specification, illustrate embodiments of the present disclosure and together with the description, serve to explain the principles of the disclosure.

FIG. 1 illustrates an exploded schematic view showing the various components of a Proton Exchange Membrane (PEM) fuel cell;

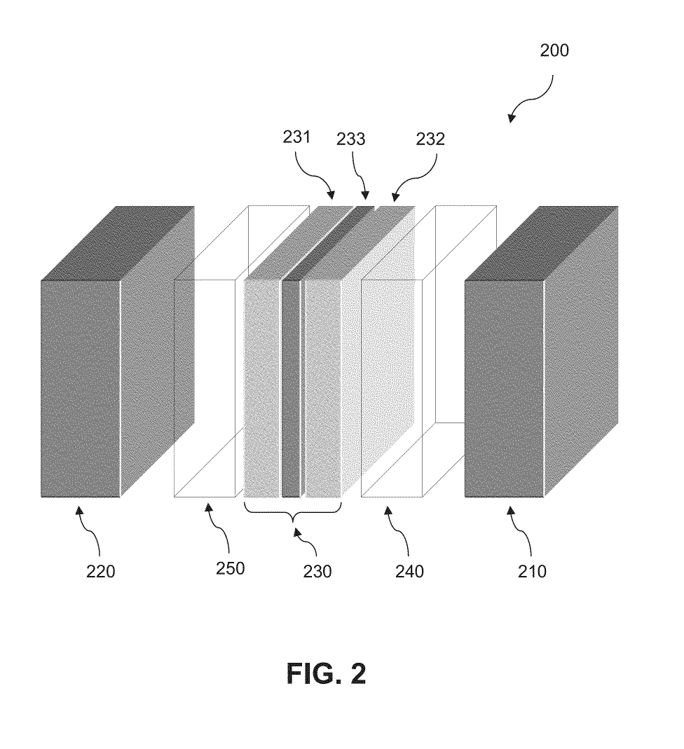

FIG. 2 is a schematic view of part of an electrochemical cell in accordance with exemplary embodiments of the present disclosure; and

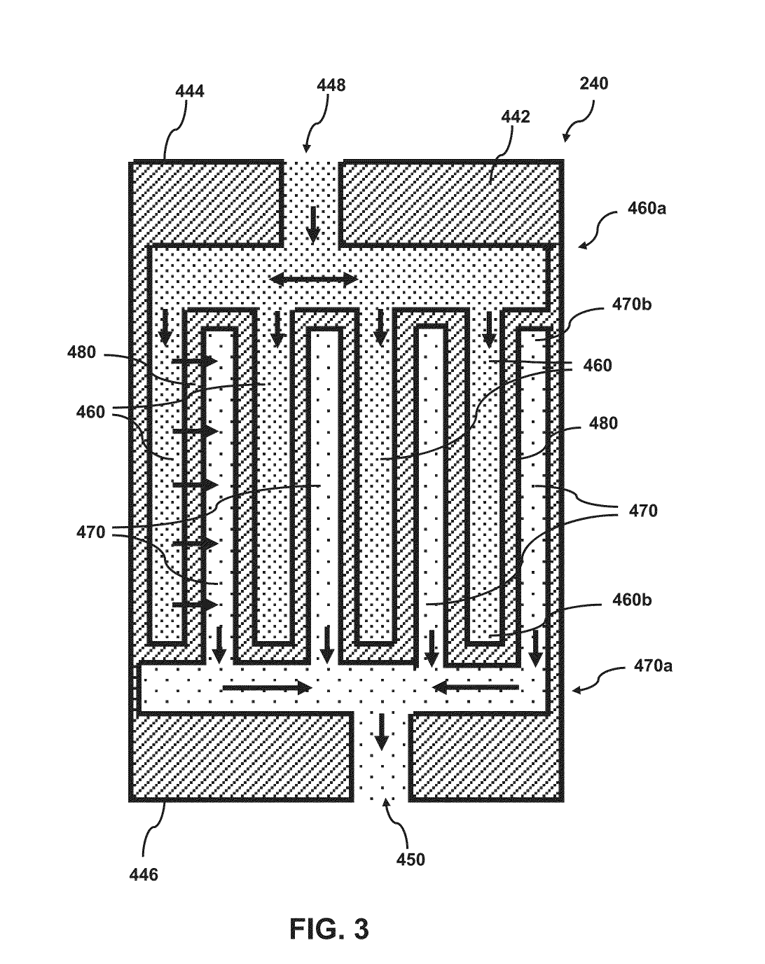

FIG. 3 illustrates a front view of a cathode flow field in accordance with exemplary embodiments of the present disclosure.

Reference will now be made in detail to the exemplary embodiments of the present disclosure, examples of which are illustrated in the accompanying drawings. Wherever possible, the sample reference numbers will be used throughout the drawings to refer to the same or like parts. Although described in relation to an electrochemical cell employing hydrogen, oxygen, and water, it is understood that the devices and methods of the present disclosure can be employed with various types of electrochemical cells, including those operating under high differential pressures.

FIG. 2 shows an exploded schematic of an exemplary electrochemical cell 200. Electrochemical cell 200 can include two bipolar plates 210, 220. The two bipolar plates 210, 220 can act as support plates and conductors. Bipolar plates 210, 220 can also include access channels for circulating cooling fluid (i.e., water, glycol, or water glycol mixture) to remove heat from cell 200. Bipolar plates 210, 220 can be made from aluminum, steel, stainless steel, titanium, copper, Ni—Cr alloy, graphite or any other electrically conductive material.

In addition to bipolar plates 210, 220, electrochemical cell 200 can include a membrane electrode assembly (“MEA”). MEA 230 can comprise an anode 231, a cathode 232, and a proton exchange membrane (“PEM”) 233. PEM 233 can be disposed between anode 231 and cathode 232 electrically insulating anode 231 and cathode 232 from each other. It is contemplated that PEM 233 can comprise a pure polymer membrane or composite membrane where other materials such as, for example, silica, heterpolyacids, layered metal phosphates, phosphates, and zirconium phosphates can be embedded in a polymer matrix. PEM 233 can be permeable to protons while not conducting electrons. Anode 231 and cathode 232 can comprise porous carbon electrodes containing a catalyst layer (not shown). The catalyst material can be, for example, platinum, which can increase the reaction rate.

As illustrated in FIG. 2, a cathode flow field 240 and an anode flow field 250 flank MEA 230. Cathode flow field 240 and anode flow field 250 can provide electrical conduction between bipolar plated 210, 220 and MEA 230, while also providing a media for transport of gases and liquid within electrochemical cell 200. In addition, cathode flow field 240 and anode flow field 250 can provide mechanical support to MEA 230.

Cathode flow field 240 and anode flow field 250 can comprise three-dimensional porous metallic structures. In certain embodiments, cathode flow field 240 and anode flow field 250 can be formed by compacting a highly porous metallic material, such as, a metallic open structure (e.g., a metallic foam, sintered metal frit, metallic mesh, metallic net, or any other porous metal). The porous metallic material can comprise a metal such as, for example, stainless steel, titanium, aluminum, nickel, iron, etc., or a metal alloy such as nick chrome alloy, etc. In some illustrative embodiments, the pore size of the metallic material can range from about 20 μm to about 1000 μm. For example, the pore size of the metallic material can range from about 20 μm to about 1000 μm, such as from about 50 μm to about 1000 μm, from about 20 μm to about 900 μm, etc, from about 30 μm to about 800 μm, from about 40 μm to about 700 μm, from about 50 μm to about 600 μm, from about 60 μm to about 500 μm, from about 70 μm to about 500 μm, from about 100 μm to about 450 μm, from about 200 μm to about 450 μm, and from about 350 μm to about 450 μm. In illustrative embodiments, the average pore size of the metallic material is about 400 μm, about 500 μm, or about 800 μm. In further embodiments, the void volume of the metallic material ranges from about 70% to about 99%. For example, the void volume of the metallic material can range from about 70% to about 98%, such as from about 75% to about 98%, from about 75% to about 95%, from about 75% to about 90%, from about 75% to about 85%, from about 70% to about 80%, from about 73% to about 77%, from about 80% to about 90%, from about 83% to about 87%, from about 90% to about 99%, and from about 93% to about 97%. In illustrative embodiments, the void volume of the metallic material can be about 75%, about 85%, or about 95%.

Electrochemical cell 200 can additionally include an electrically conductive gas-diffusion layer (GDL) on each side of MEA 230. It is contemplated that the porous metallic structure can perform the functions typically required of GDLs, thereby introducing the possibility of eliminating the GDLs from the electrochemical cell assembly. In an alternative embodiment, a porous metallic structure consisting of two distinct layers having different average pore sizes (for example, larger pores constituting the flow field and smaller pores replacing the GDL) can be placed in contact with MEA 230. Accordingly, as used herein “flow field” refers to both a flow field and GDL, unless specified otherwise. It is within the scope of the present disclosure to use the disclosed porous metallic flow fields with conventional GDLs or with conventional channel-type flow fields.

A front view of an exemplary flow field, for example, cathode flow field 240 is shown in FIG. 3. Although the following description is in reference to cathode flow field 240, it is equally applicable to anode flow field 250. As illustrated, cathode flow field 240 may include a longitudinally extending surface 442 defining a first edge 444 and a second edge 446. An inlet port 448 can be disposed at first edge 444, and an outlet port 450 can be disposed at second edge 446. It will be understood that inlet port 448 and outlet port 450 can be located at any other position or structure on cathode flow field 240. Inlet port 448 and outlet port 450 can comprise apertures partially or fully extending across the thickness of cathode flow field 240. Inlet port 448 can be configured to receive a reactant gas (e.g., fuel, oxygen, or air) and outlet port 450 can be configured to remove the depleted gas from cathode flow field 240.

As illustrated, cathode flow field 240 can include a plurality of inlet (or first) channels 460 and a plurality of outlet (or second) channels 470. Inlet channels 460 and outlet channels 470 may be stamped or otherwise formed in cathode flow field 240. The plurality of inlet channels 460 and plurality of outlet channels 470 can be substantially free of obstructions to fluid flow to allow improved distribution of the reactant gas. While four inlet and outlet channels are depicted in FIG. 3, it will be understood that a greater or lesser number of inlet and/or outlet channels may be provided.

The plurality of inlet channels 460 can be formed within a structure or on surface 442 of cathode flow field 240, and extend from first edge 444 (e.g., a proximal end of cathode flow field 240) to second edge 446 (e.g., a distal end of cathode flow field 240). The plurality of outlet channels 470 can also be formed within surface 442 of cathode flow field 240, and extend from second edge 446 (e.g., distal end of cathode flow field 240) to first edge 444 (e.g., proximal end of cathode flow field 240). Surface 442 can be, for example, a surface of cathode flow field 240 facing towards MEA 230. It will be understood that channels may be formed on a structure or surface associated with cathode flow field 240. In the exemplary embodiment, the plurality of inlet channels 460 can be parallel to the plurality of outlet channels 470 with each of the plurality of outlet channels 470 being disposed between adjacent inlet channels 460. Other arrangements of inlet channels 460 and outlet channels 470 are contemplated.

Each of the plurality of inlet channels 260 can have a first proximal end 460a disposed at, adjacent, or near first edge 444. First proximal end 460a can be in fluid communication with inlet port 448 to receive a reactant gas. In the exemplary embodiment, first proximal end 460a of inlet channels 460 can be “open ends” in fluid communication with each other and inlet port 448 so as to form a fluid pathway between the plurality of inlet channels 460. With this arrangement, the flow of reactant gas from inlet port 448 can be uniformly distributed through the plurality of inlet channels 460.

Each of the plurality of inlet channels 460 can terminate within cathode flow field 240 at a first distal end 460b. In some embodiments, first distal end 460b can be disposed between first edge 444 and distal ends of the plurality of outlet channels 470. First distal end 460b can be a “dead-end” or “closed end” that is not in direct fluid communication with outlet port 450. With this arrangement, a reactant gas distributed in each inlet channel 460 can be forced to diffuse through the porous metallic structure to an adjacent outlet channel 470. In some embodiments, a plurality of micro channels 480 may be formed in cathode flow field 240 in the portion separating adjacent inlet channels 460 and outlet channels 470. Micro channels 480 may be formed along the entire length or just a portion of the separating portion. Micro channels 480 may fluidly connect inlet channels 460 and outlet channels 470. Micro channels 480 may be configured to direct flow of the reactant gas from inlet channels 460 to the adjacent outlet channels 470. Micro channels 480 may be sized and spaced in such a way to provide oxygen availability to a majority of catalyst sites that would otherwise by shadowed by the portion of cathode flow field 240 porous structure that separates inlet channels 460 and outlet channels 470.

The plurality of inlet channels 460 can extend substantially across cathode flow field 240 along the direction of flow (e.g., a length dimension). In some embodiments, inlet channels 460 may have a length in the range of 90 mm to 150 mm. Additionally, the plurality of inlet channels 460 can be uniformly distributed across a dimension of cathode flow field 240 traverse to the direction of flow (e.g., a width dimension). The plurality of inlet channels 460 can have any suitable width, cross-sectional area, depth, shape, and/or configuration to, for example, distribute reactant gas received at inlet port 448 along the length of each of the plurality of inlet channels 460. In some embodiments, inlet channels 460 may have a width in the range of 0.1 to 1.5 mm. It is contemplated that, in certain embodiments, the plurality of inlet channels can have different shapes and/or cross-sectional areas.

Each of the plurality of outlet channels 470 can include a second distal end 470a disposed at, adjacent, or near second edge 446, and in communication with outlet port 450. Second distal end 470a can be in fluid communication with outlet port 450 to expel the reactant gas from cathode flow field 240. In the exemplary embodiment, second distal ends 470a of the plurality of outlet channels 470 can be “open ends” in fluid communication with each other and outlet port 450 so as to form a fluid pathway to uniformly remove gas from the plurality of outlet channels 470.

Each of the plurality of outlet channels 470 can extend from second distal end 470a towards first edge 444, and terminate within cathode flow field 240 at a second proximal end 470b. In some embodiments, second proximal end 470b can be disposed between second edge 446 and first proximal ends 460a of the plurality of inlet channels 460. Second proximal end 470b can be a “dead-end” or “closed end” that is not in direct fluid communication with inlet port 448. With this arrangement, at least between second proximal end 470b and second distal end 470a outlet channels 470 can receive reactant gas from an adjacent inlet channel 460.

The plurality of outlet channels 470 can also extend substantially across cathode flow field 240 (e.g., a length dimension). In some embodiments, outlet channels 470 may have a length in a range of 90 mm to 150 mm. Additionally, the plurality of outlet channels 470 can be uniformly distributed across a dimension of cathode flow field 240 traverse to the direction of flow (e.g., a width dimension). The plurality of outlet channels 470 can have any suitable width, cross-sectional area, depth, shape, and/or configuration to, for example, to direct reactant gas that diffused from inlet channels 460 through the porous metallic structure into the outlet channels 470 toward outlet port 450. In some embodiments, outlet channels 470 may have a width in the range of 0.3 to 1.5 mm. It is contemplated that, in certain embodiments, the plurality of outlet channels 470 can have different shapes and/or cross-sectional areas. Additionally, it is contemplated that the plurality of outlet channels 470 can have the same or different shapes and/or cross-sectional areas compared to the plurality of inlet channels.

During operation of electrochemical cell 200, a reactant gas can be supplied to cathode flow field 240 through inlet port 448. The reactant gas can diffuse from inlet port 448 through the porous metallic structure into the plurality of inlet channels 460. In particular, the reactant gas can flow into first proximal ends 460a of each of the plurality of inlet channels 460, and distribute along the length of each inlet channel 460 between first proximal end 460a and first distal end 460b.

First distal end 460b can be a dead end or closed end which can force the reactant gas distributed along the length of each of the plurality of inlet channels 460 to flow through (e.g., diffuse) the metallic porous structure into an adjacent outlet channel 470. This results in forced convection of the reactant gas toward the catalyst and relatively greater exposure of the reactant gas to the catalyst. In some embodiments, in conjunction with diffusing or rather than diffusing, the reactant gas may flow through micro channels 480 from inlet channels 460 to outlet channels 470.

Upon entering the adjacent outlet channel 470, the reactant gas can flow away from second proximal end 470b and toward second distal end 470a to distribute along a length of each of the outlet channels 470. The reactant gas can then flow from second distal end 470a through outlet port 450 to be removed from cathode flow field 240.

The present disclosure may present a number of benefits. For example, the inlet and outlet channels of the disclosed cathode fluid field provide a larger cross-sectional area through which the reactant gas can flow, which can reduce the pressure drop across the porous metallic flow field compared to other porous metallic fluid field structures. In addition to the inlet and outlet channels, the micro channels of the disclosed cathode flow field may also provide an increased cross-sectional area through which the reactant gas can flow between the inlet channels and the outlet channels, which can further reduce the pressure drop across the porous metallic flow field. This can reduce the amount of energy required to pressurize the reactant gas (i.e., reduce blower power), which, in turn, can improve the overall performance and efficiency (e.g., improve power density and reduce parasitic loading) of the fuel stack. Additionally, the disclosed cathode flow field can reduce the flow length the reactant gas needs to travel within the porous metallic flow field compared to other porous flow field structures without channels. This can allow the incoming flow to remain oxygen rich until the flow is directed through the porous body, thus improving cell oxygen distribution. By doing so, the disclosed cathode flow fields can result in better catalyst utilization and potentially higher current density.

In some additional and/or alternative embodiments, it is contemplated that the plurality of inlet channels 460 and plurality of outlet channel 470 can be formed in bipolar plates 210, 220 and used in conjunction with three-dimensional porous metallic flow fields. Such an arrangement can result in similar functionality as described above, but would result in a thicker cell which could lower the overall power density of the fuel stack.

Other embodiments of the present disclosure will be apparent to those skilled in the art from consideration of the specification and practice of the present disclosure herein. It is intended that the specification and examples be considered as exemplary only, with a true scope and spirit of the present disclosure being indicated by the following claims.

What is claimed is:

1. A flow field for use in an electrochemical cell comprising:
a porous metallic structure including an inlet port and an outlet port;
a plurality of first channels formed in the structure, wherein each of the plurality of first channels extends from a first proximal end in fluid communication with the inlet port and terminates at a first distal end within the structure; and
a plurality of second channels formed in the structure, wherein each of the plurality of second channels extends from a second distal end in fluid communication with an outlet port and terminates at a second proximal end within the structure.

2. The flow field of claim 1, wherein the porous metallic structure includes a metallic open structure that includes at least one of a metallic foam, a metallic mesh, or metallic net.

3. The flow field of claim 1, wherein the structure includes a first edge and a second edge, wherein the inlet port is disposed on the first edge and the outlet port is disposed on the second edge.

4. The flow field of claim 3, wherein the first distal end of each of the plurality of first channels terminates between the first edge and the second distal end of the plurality of second channels.

5. The flow field of claim 3, wherein the second proximal end of each of the plurality of second channels terminates between the second edge and the first proximal end of the plurality of first channels.

6. The flow field of claim 1, wherein the plurality of first channels and the plurality of second channels are arranged in parallel.

7. The flow field of claim 1, wherein at least one of the plurality of first channels is disposed between adjacent second channels.

8. The flow field of claim 1, wherein each of the plurality of first channels is configured to cause a reactant gas to diffuse through the porous metallic structure from one of the plurality of first channels to an adjacent one of the plurality of second channels.

9. The flow field of claim 1, further including a plurality of micro channels formed in the flow field fluidly connecting the first channels to the second channels.

10. The flow field of claim 9, wherein the micro channels are arranged in the metallic porous structure between adjacent first channels and second channels.

11. An electrochemical cell comprising:
a first bipolar plate;
a second bipolar plate;
a membrane electrode assembly comprising a cathode, an anode, and a polymer membrane disposed between the cathode and the anode;
at least one flow field disposed between one of the first bipolar plate and the second bipolar plate and the membrane electrode assembly, the flow field being formed of a porous metallic structure having an inlet port and an outlet port, the structure including a plurality of inlet channels in fluid communication with the inlet port, and a plurality of outlet channels interposed between each of the plurality of inlet channels and in fluid communication with the outlet port.

12. The electrochemical cell of claim 11, wherein the flow field is a longitudinally extending surface facing towards the membrane electrode assembly.

13. The electrochemical cell of claim 11, wherein each of the plurality of inlet channels extends from a first proximal end in fluid communication with the inlet port and terminates at a first distal end.

14. The electrochemical cell of claim 13, wherein the first distal end is disposed at or adjacent the second edge.

15. The electrochemical cell of claim 11, wherein each of the plurality of outlet channels extends from a second distal end in fluid communication with the outlet port and terminates at a second proximal end.

16. The electrochemical cell of claim 15, wherein the second proximal end is disposed at or adjacent the first edge.

17. The electrochemical cell of claim 11, wherein each of the plurality of inlet channels is configured to cause a reactant gas to diffuse through the porous metallic structure from one of the plurality of inlet channels to an adjacent one of the plurality of outlet channels.

18. The electrochemical cell of claim 11, wherein the porous metallic structure includes a metallic open structure that includes at least one of a metallic foam, a metallic mesh, or metallic net.

19. The electrochemical cell of claim 11, wherein the at least one flow field further includes a plurality of micro channels formed in the flow field fluidly connecting the first channels to the second channels.

20. The electrochemical cell of claim 19, wherein the micro channels are arranged in the metallic porous structure between adjacent first channels and second channels.
